(19) United States
(12) Patent Application Publication
(10) Pub. No.: US 2026/0105589 A1
(43) Pub. Date: Apr. 16, 2026

(54) MOTHERBOARD CORRUPTION DETECTION

(71) Applicant: Dell Products L.P., Round Rock, TX (US)

(72) Inventors: Rômulo Teixeira de Abreu Pinho, Niterói (BR); Adriana Bechara Prado, Niterói (BR); Ravi Shukla, Bangalore (IN); Jeffrey Scott Vah, Round Rock, TX (US); Aaron Sanchez, Austin, TX (US); Aditi Saluja, Austin, TX (US)

(21) Appl. No.: 18/916,913

(22) Filed: Oct. 16, 2024

(51) Int. Cl. G06T 7/00

(52) U.S. Cl. CPC G06T 7/001; G06T 2207/20081; G06T 2207/20216; G06T 2207/30141

(57) ABSTRACT

A computer vision approach for detecting anomalies in computing components. A model is trained to learn what healthy computing components look like using corrupted images generated from a healthy image. The model is trained to generate healthy data for each of the corrupted images. A test image of a computing component under test or evaluation is generated and corrupted images of the test image are input to the trained model. The output of the trained model is compared to the test image. Differences are indicative of anomalies in the computing component under test.

### TECHNOLOGICAL FIELD OF THE DISCLOSURE

Embodiments disclosed herein generally relate to detecting corruption in computing systems and components. More particularly, at least some embodiments relate to systems, hardware, software, computer-readable media, and methods for detecting corruption in computing systems, including motherboards, using generative artificial intelligence/machine learning (AI/ML).

### BACKGROUND

One of the issues related to computing equipment is fraud. Motherboard fraud relates, in most cases, to scenarios in which PCB (Printed Circuit Board) components are intentionally not installed, or are removed from the motherboard during manufacture, during transit to repair centers, or at distribution hubs where the removed components are sold off in parallel markets for profit. Unfortunately, this type of problem is usually perceived only after a computing system is purchased and the malfunctioning computing system is sent to a repair center.

A repair technician often needs to spend considerable time to determine that the malfunction stems from a missing component. After determining that the problem is a missing component, the technician spends time visually inspecting the motherboard to identify exact locations where missing components should be present as per the BOM (bill of materials).

This is a very difficult task at least because a majority of 2,000 plus components on a motherboard are difficult to locate without microscopes, and are often unlabeled. As a result, the customer is frustrated, the brand is negatively impacted, and substantial economic losses may be incurred.

Aspects of addressing fraud include trying to prevent the fraud from occurring when possible and/or detecting the fraud as quickly as possible. With regard to quickly detecting fraud, artificial intelligence and machine learning has been considered as a way to augment manufacturing inspection mechanisms and/or making the work performed in repair centers more efficient.

However, solutions that use artificial intelligence/machine learning require labelled data for training purposes. In these solutions, the machine learning models are trained in a supervised manner so that the machine learning models learn to recognize the different classes of data to be processed. Unfortunately, fraud events are likely to be rare and are therefore anomalies within an otherwise normal process. This complicates the training process.

More specifically, in supervised artificial intelligence/machine learning for anomaly detection, a common approach is to train a model to learn to differentiate normal cases from anomalous cases for some input data. Nonetheless, obtaining enough data about the (rare) anomalous event is a frequent challenge in artificial intelligence/machine learning solutions for anomaly detection. In the case of motherboard fraud, it is virtually impossible to have enough data about fraudulent motherboards because these motherboards are scrapped. Historically, some repair teams only have access to 2-4% of images associated with fraud events.

Another approach to artificial intelligence/machine learning for anomaly detection is to train a model to only learn the normal operation of some process and establish boundaries of normal behavior. After the model is trained, the model may receive a test case and predict some behavior outside of the normal boundaries. When behavior outside of the normal boundaries is predicted, the case is flagged as potentially anomalous. This approach removes the need to collect anomalous samples for a supervised learning task.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of detecting missing parts or components in a computing system, device, or component;

FIG. 2 discloses aspects of inpainting performed by an inpainting model;

FIG. 3A discloses aspects of a data preparation phase that includes preparing a dataset for training a model;

FIG. 3B discloses aspects of training a model to generate healthy images from corrupted images;

FIG. 4A discloses aspects of systems and methods for evaluating or testing a new image of a motherboard when a status of the motherboard is unknown using a model trained to generate healthy data or healthy images;

FIG. 4B discloses additional aspects of determining whether a motherboard is healthy or unhealthy based on an image of the motherboard;

FIG. 5 discloses aspects related to aggregating images and visualizing the results of comparing an aggregated image with an input image; and

FIG. 6 discloses aspects of a computing device, a computing system, or a computing entity.

### DETAILED DESCRIPTION OF SOME EXAMPLE EMBODIMENTS

Embodiments disclosed herein generally relate to detecting anomalies in computing components and computing systems. More particularly, at least some embodiments relate to systems, hardware, software, computer-readable media, and methods for detecting anomalies in computing systems/components, including motherboards, using generative artificial intelligence/machine learning.

Embodiments of the invention are discussed in the context of motherboards, but may be applied generally to inspecting other computing components or non-computing components. By way of example, embodiments of the invention are discussed in the context of identifying unhealthy motherboards, which may be indicative of fraud. By way of example, an unhealthy motherboard may be missing components or exhibit other anomalies. Components that are removed intentionally or deliberately result in an unhealthy motherboard. Components that are installed incorrectly or not installed during manufacture/repair may also represent unhealthy motherboards. The ability to detect unhealthy motherboards (e.g., by detecting anomalies such as missing components) has various applications including, but not limited to, fraud detection, quality assurance, and the like.

Conventionally, images of motherboards can be used for inspection purposes. When using images of motherboards for these purposes, a canonical reference picture or image of a healthy motherboard after manufacture of the motherboard is completed. As motherboards are being manufactured and assembled, sample images of the motherboards may be optionally taken again under the same lighting and positional conditions as the canonical reference. A grid is overlayed on each image. In one example, an operator visually inspects the images inside the grid cells for any differences and signals any problems accordingly. If the comparison is not done manually, a difference image between the contents of corresponding cell grids could be generated and displayed. These methods, however, require a reference image.

Embodiments of the invention advantageously do not require a reference image and can be performed automatically. Rather, embodiments of the invention are configured to generate inferences using only the test image of the motherboard being tested. In other words, the test image is the reference image in one example. Further, sophisticated photographing equipment, similar lighting conditions, or the like are not required for embodiments of the invention.

Embodiments of the invention include a computer vision approach for motherboard anomaly detection that includes learning what normal (or healthy) motherboards (i.e., with all the components in place) look like. In example embodiments, generative models for images are configured to accelerate the process of identifying locations on motherboards that may be missing components and are therefore unhealthy. As previously indicated, no image data for unhealthy motherboards is required to train the model.

Embodiments of the invention generate data, train a model, and use the model to generate predictions related to detecting motherboards that are not healthy. Embodiments of the invention may also provide a visualization indicating the potential locations of missing components.

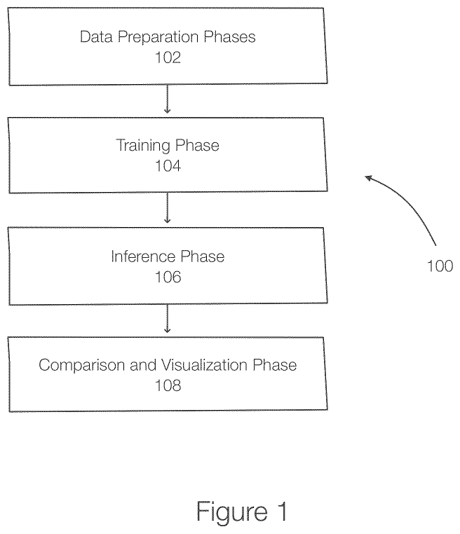

FIG. 1 discloses aspects of detecting anomalies (e.g., missing parts or components) in a motherboard. In one example, detecting missing components may be indicative of fraud. FIG. 1 illustrates aspects or phases of identifying motherboards with missing components. The method 100 includes a data preparation phase 102. In the data preparation phase 102, a set of images of healthy motherboards are obtained. The images are programmatically corrupted in a controlled manner to generate sets of corrupted images. Each healthy image is associated with a set of corrupted images. In one example, the corruption protocol masks pre-determined areas of the healthy images to generate the corrupted images.

The training phase 104 includes training a model using the dataset prepared in the data preparation phase 102. In one example, the model is an inpainting model and the inpainting model is trained from scratch. The model is trained to reconstruct the corrupted images to be as close as possible to the original healthy or uncorrupted image. Thus, the model “thinks” that only healthy motherboards exist regardless of the input. Thus, the model being trained in the training phase 104 is specialized in generating images of healthy motherboards.

Once the model is trained, the model may be deployed and an inference phase 106 may be performed. The model does not know whether the motherboard under inspection (test motherboard) is healthy (e.g., not missing components) or unhealthy (e.g., missing components). In the inference phase 106, an image of a motherboard to be tested or evaluated is obtained. The image of the test motherboard is corrupted using the same corruption protocol used in the training phase 104. For each corrupted image generated from the image of the test motherboard, the model attempts to reconstruct the corrupted image based on its training (how healthy motherboards look). Thus, the model generates data or content for the masked region or area of the corrupted images to generate the healthy estimate images.

In other words, the model generates healthy equivalents or healthy estimate images that correspond to the corrupted images of the original input image. The healthy estimate images generated by the model in response to inputting the corrupted images are then patched (or aggregated) into one output or aggregated image. The aggregated image is compared to the image of the motherboard being tested. This allows unhealthy motherboards to be detected (or healthy motherboards to be confirmed) using only the original image of the test motherboard as a reference image. An unhealthy motherboard can be detected because the model generates healthy data for the masked regions of the corrupted images generated from the image of the motherboard being tested. As a result, areas in the original test image in which the motherboard is unhealthy (e.g., missing components) will differ more with the aggregated image compared to differences between an image of a healthy motherboard and a corresponding aggregated image. This may be manifested, for example, in a heatmap. An aggregated image of a healthy motherboard is likely to closely match the original image of the motherboard. The aggregated image of an unhealthy motherboard is likely to have comparatively more differences when compared to the original image of the motherboard being tested.

The comparison and visualization phase 108 is performed after the inference phase 106. In one example, the output of the model is expected to be different depending on whether the input image corresponds to a healthy motherboard or an unhealthy motherboard. In the case of healthy motherboards, the input image and output image (reconstructed or aggregated image) are expected to be very similar because the generated content over the masked regions tends to be consistent with surrounding regions. Therefore, masked healthy regions will likely be reconstructed to be something similar to a healthy motherboard because the model is trained to generate healthy images.

In the case of unhealthy motherboards, the input to the model and the output of the model are expected to be different over the regions of the input or test images that correspond to unhealthy regions of the motherboards. This is because the model will replace the masked region with content that resembles a healthy motherboard consistent with the surrounding regions. Through the comparison, areas of the input image that are candidates for closer inspection may be identified in a fully automated fashion.

The differences between the input image and the aggregated image can be measured, quantified, and scaled into a heatmap (or a colored heatmap). Regions of the heatmap that correspond to the highest colors on the color scale correspond to potential regions of missing components on the test motherboard image because they correspond to the largest differences between the input image and the output or aggregated image. With this visualization (the color heatmap or an overlay of the heatmap with the input image), technicians can more easily determine whether a motherboard being assessed is unhealthy or even fraudulent. Further, embodiments of the invention identify areas of the motherboard for further inspection. This allows the examination by the technician to focus on areas of the motherboard that are more likely to be unhealthy (e.g., missing components, which may be indicative of fraud).

Learning visual aspects of healthy motherboards allow regions of motherboards that are missing components to be detected. Further, regions of the motherboard that may be missing components or are otherwise unhealthy can be identified in an automated manner.

In one example, an inpainting model is used in a manner that allows anomalies in the motherboard being tested to be detected from the test image itself. Generally, inpainting is a generative task whose objective is to complete an area of an image that has been masked in such a way that the completed content makes sense with the rest of the image. Inpainting generative models are typically trained by masking images from a dataset in random or controlled manners and letting the model reconstruct the masked area in such a way that the reconstructed content resembles the original content on the source image.

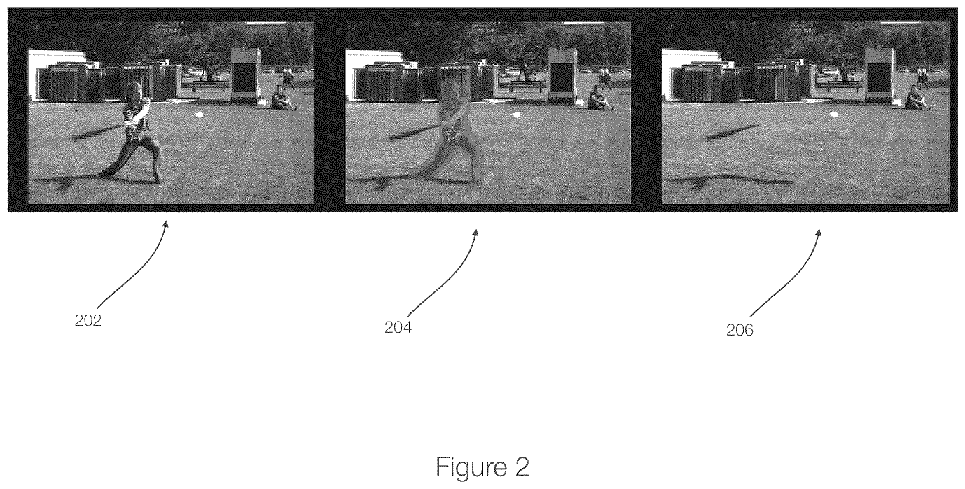

FIG. 2 discloses aspects of inpainting performed by an inpainting model. FIG. 2 illustrates an image 202. This image 202 may be an original image of a person in an environment. The image 204 corresponds to the image 202 but includes a mask that masks an area occupied by the person in the image 202. The image 206 is an image generated by an inpainting model. In this example, the model is configured to fill the area corresponding to the mask with content that is consistent with the surroundings from the image 202 or learned during training. In this case, the area corresponding to the mask is replaced with grass, which surrounds the area covered or occupied by the mask. At inference time with a trained model, the user masks a region of interest of an input image as illustrated in the image 204 and the trained model fills the masked region with content or characteristics that are consistent with the surroundings. In embodiments of the invention, the trained model fills the masked regions with healthy content because the model was trained only with healthy images.

Embodiments of the invention adapt the masking and inferencing steps in order to detect unhealthy motherboards from their images. In some examples, when an anomaly is indicated or detected, the anomaly may indicate fraud.

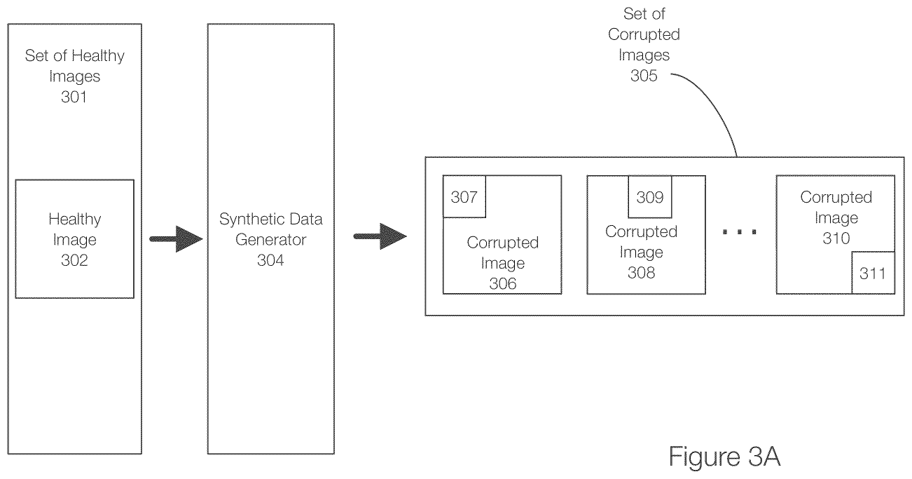

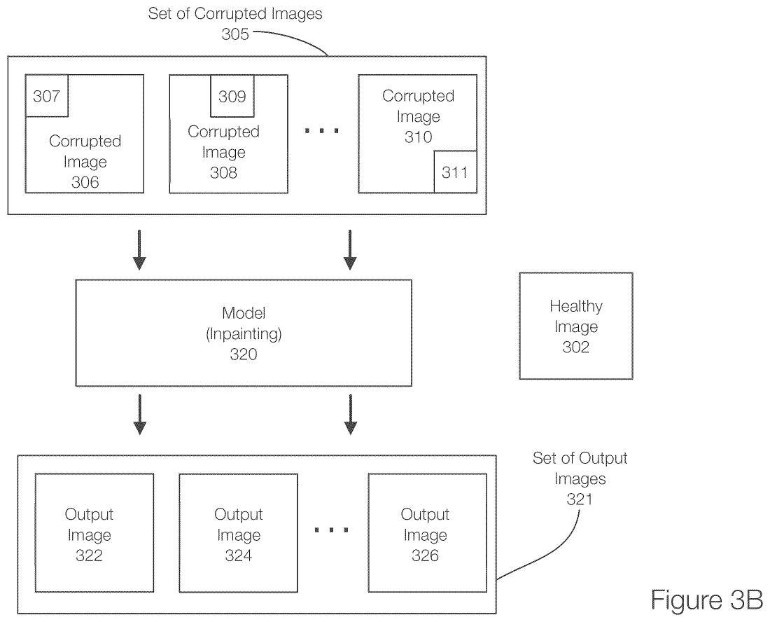

FIG. 3A discloses aspects of a data preparation phase, such as the phase 102, that includes preparing a dataset for training a model. FIG. 3A illustrates a set of healthy images 301. The healthy images 301 are represented by the healthy image 302. In this example, a set of corrupted images 305 is generated from the healthy image 302. Sets of corrupted images are generated for all of the healthy images in the set of healthy images 301.

By way of example, the healthy image 302 is input into a synthetic data generator 304. The synthetic data generator 304 generates the set of corrupted images 305 by placing a mask over different locations of the healthy image 302. In this example, the mask 307 is placed at a first location in the corrupted image 306. The mask 309 (which may have the same characteristics (e.g., size) as the mask 307, is placed at a different location in the corrupted image 308. As illustrated, the mask is placed at different locations to generate the set of corrupted images 305. The last corrupted image 310 of the set 305 includes the mask 311.

More specifically, a process is performed for each image h in a set of healthy images H. A corrupted image h′ is generated by overlapping the mask (e.g., a black rectangle) on the image h and the pair (h, h′) is stored. The mask is moved to a neighboring position in the image h that has not been masked and another pair is generated. This is repeated until the mask has traversed the entire image h. The set of corrupted images 305 thus represents a dataset H′ that includes (e.g., n) image pairs (h, h′) or n corrupted images h′. This is performed for each image h in H. Generating the corrupted images may be perform such that the regions covered by the mask do not overlap and such that, when the set 305 is considered collectively, all portions of the healthy image 302 have been masked.

FIG. 3B discloses aspects of training a model to generate healthy estimate images for corrupted images. FIG. 3B is discussed with respect to the set of corrupted images (or image pairs) 305 associated with a healthy image 302 previously discussed. FIG. 3B illustrates a portion of training the model 320. More specifically, the model 320 is trained using the sets of corrupted images generated for the healthy images included in the set of healthy images 301.

The model 320, which may be an inpainting model, is trained to learn the visual appearance of healthy motherboards. The model is trained with the dataset H′, including image pairs (h, h′). FIG. 3B illustrates a batch of images used in training. Thus, the corrupted images 306, 308, and 311 (or other set of corrupted images) are input to the model 320 during training and the model learns to fill the masked portions of the corrupted images so that the output images 322, 324, and 326 are as close as possible to the original healthy image 302. By training the model 320 from scratch in one example, the model 320 learns to generate images patterns of healthy images only.

In the inference phase, the trained model receives a new or test image of a motherboard. The model, however, does not know whether the test image represents a healthy motherboard or an unhealthy motherboard. The data generator is applied to the test image to generate corrupted images corresponding to the test image. The corrupted images are input to the model and an output image is generated for each of the corrupted images input to the trained model. As previously stated, the model fills the masked areas of the corrupted images with content corresponding to healthy images. The output images or healthy estimate images are aggregated into a single image (an aggregated image). The aggregated image is compared to the original input image (the test image being evaluated). By comparing the aggregated image with the test image, an inference can be made regarding whether the test image represents a healthy motherboard or an unhealthy motherboard.

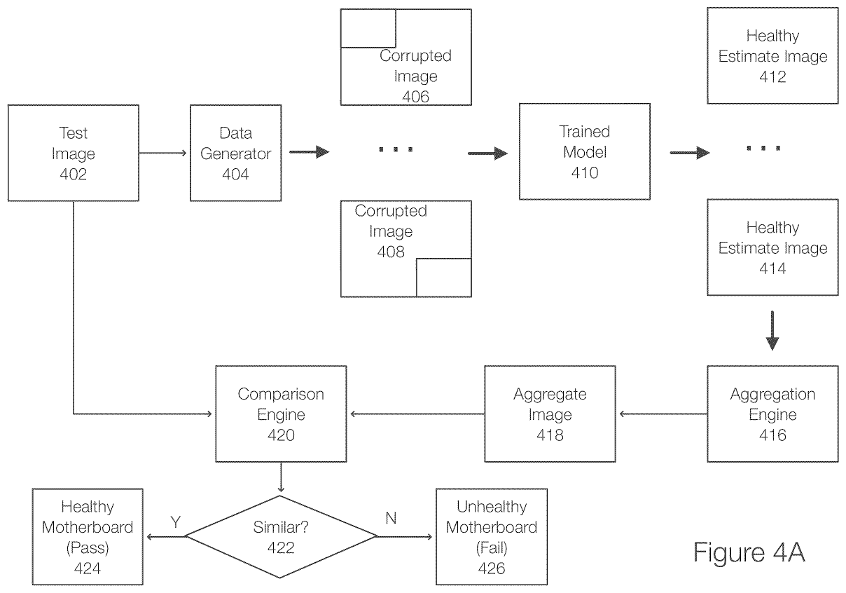

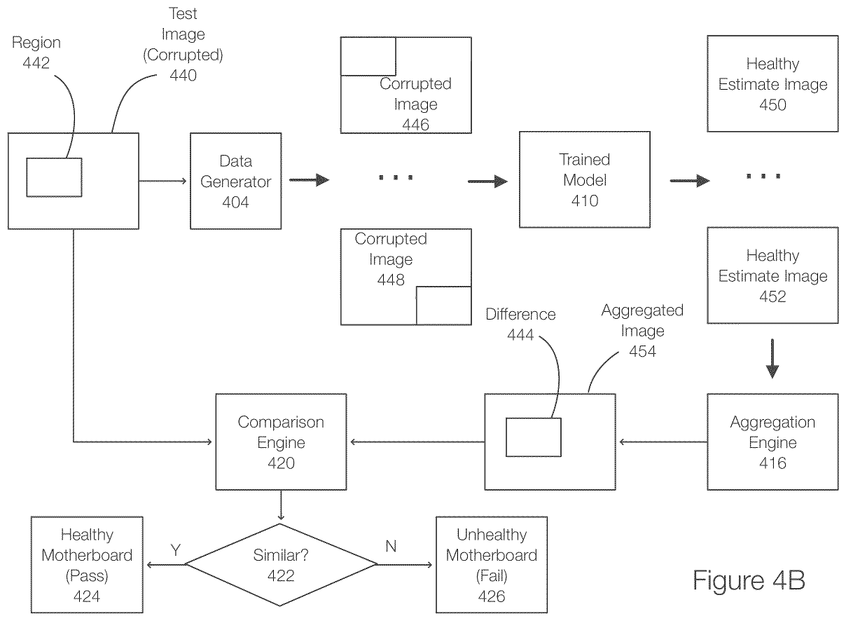

FIG. 4A discloses aspects of systems and methods of evaluating or testing a new input image of a motherboard when a status of the motherboard (e.g., healthy or unhealthy) is unknown using a model trained to generate healthy data or healthy images. Although the status of the input image 402 is unknown in practice, FIG. 4A illustrates a scenario when the image 402 is a healthy image of a healthy motherboard.

In FIG. 4A, an input or test image 402 is received and evaluated or tested using a trained model 410, which is an example of the model 320. More specifically, the test image 402 is input to a data generator 404 and a set of corrupted images, represented by the corrupted images 406 and 408, is generated. The process of generating the corrupted images 406 and 408 is the same process used in generating the training dataset of corrupted images.

The corrupted images 406 and 408 are input to a trained model 410 and the trained model 410 generates output images for each of the corrupted images into to the trained model 410. Thus, the output images is a set of healthy estimated images, represented by the healthy estimate images 412 and 414. Thus, the healthy estimate image 412 is an output image generated by the model 410 for the input corrupted image 406. The other healthy estimate images output by the trained model correspond to the other corrupted images input to the trained model 410.

Because the model 410 has been trained only on healthy images, the masks present in the corrupted images 406 and 408 are filled with content or data corresponding to healthy images by the model 410. More specifically, the data generated by the model 410 is generated in the context of having learned only from healthy images. Stated differently, the model 410 reconstructs the area or regions that are masked in the corrupted images to include healthy content or to include an estimate of healthy content. The area or regions that are masked are filled with content or data consistent with the portions of the images surrounding the mask based on being trained with healthy images.

Once the output images (set of healthy estimate images represented by images 412 and 414) are generated, an aggregation engine 416 generates an aggregated image 418.

The aggregated image 418 is compared to the test image 402 by a comparison engine 420. When the aggregated image 418 is similar to the test image 402, the motherboard associated with the test image 402 is healthy. Thus, the corresponding motherboard passes inspection in one example.

FIG. 4B discloses additional aspects of determining whether a motherboard is healthy or unhealthy based on an image of the motherboard. FIG. 4B is similar to FIG. 4A, but illustrates a scenario where the test image corresponds to an unhealthy motherboard or to a motherboard that includes an anomaly. In this example, the test image 440 includes (or represents) a region 442 of a motherboard that corresponds to an anomaly. Thus, the test image 440 is an image of an unhealthy motherboard in this example.

However, the process of FIG. 4B is generally the same as that in FIG. 4A. Thus, the data generator 404 generates a set of corrupted images represented by corrupted images 446 and 448 using the test image 440 as the input image.

Next, the trained model receives the corrupted images 446 and 448 and generates corresponding output images, represented by healthy estimate images 450 and 452. The aggregation engine 416 aggregates the healthy estimate images 450 and 452 to generate an aggregate imaged 454. The aggregated image 454 includes a difference 444. The difference 444 represents healthy data that was generated by the trained model 410.

The comparison engine 420 can be used to determine that the motherboard corresponding to the test image 440 is an unhealthy motherboard because the data in the region 442 of the test image 440 corresponding to the missing component of the motherboard being testes will be different from the healthy data generated by the model 410 and included in the difference 444.

The difference 444 may be identified by the comparison engine 420. More specifically, the comparison engine 420, when comparing the test image 440 with the aggregated image 454, may determine that the images 440 and 454 are not sufficiently similar (N at 422), particularly in the region 442 corresponding to the missing component. In this case, the image 440 fails the comparison and the motherboard corresponding to the test image 440 is determined to be an unhealthy motherboard 426 and may be further inspected, for example, by a technician.

Advantageously, the aggregate image 454 may provide a starting point for the analysis and focus the efforts of the technician. For example, the technician may begin evaluation of the motherboard being tested in the region corresponding to the difference 444.

In other words, when the healthy estimate images 450 and 452 are aggregated, the aggregate image 454 is likely to be different from the image 440 over the regions that indicate anomalies (e.g., the region of the motherboard corresponding to the difference 444. This is because the trained model 410 has been trained to fill the masked regions with data corresponding to healthy content. As a result, the aggregated image 454 may represent what the image of the motherboard under test should look like if healthy. Because it is assumed that the motherboard under test in this example is unhealthy, comparing the aggregated image 454 with the image 440 will indicate that the motherboard corresponding to the image 440 is unhealthy.

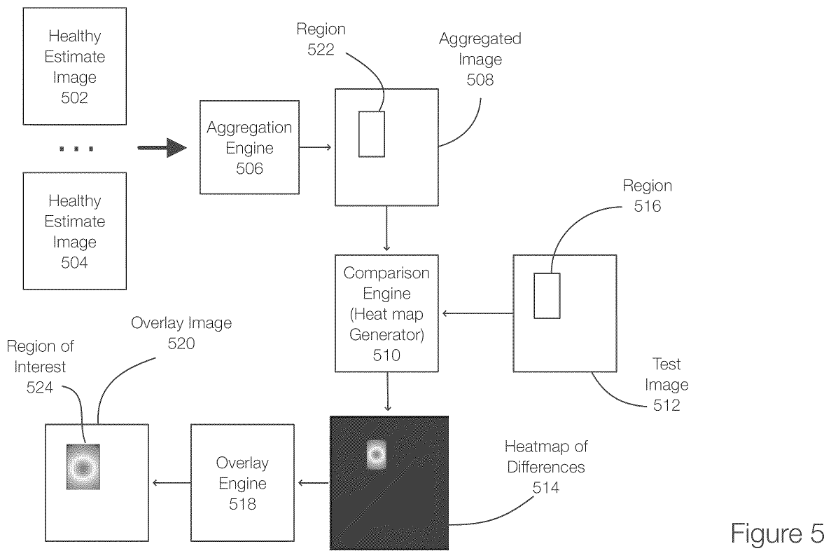

FIG. 5 discloses additional aspects related to aggregating images, and visualizing the results of comparing an aggregated image with an input or test image. FIG. 5 illustrates aspects of FIGS. 4A and 4B and discloses further aspects of the systems and methods when the original input or test image is of an unhealthy (or fraudulent) motherboard.

In FIG. 5, a set of healthy estimate images, represented by healthy estimate images 502 and 504 are output by a trained model. The aggregation engine 506 aggregates the healthy estimate images 502 and 504 to generate an aggregated image 508. In one example, the aggregated image 508 is generated by averaging the healthy estimate images 502 and 504. For example, the pixels of the healthy estimate images may be averaged to generate the pixels of the aggregated image 508.

As previously stated, the input image 512 is assumed to represent an unhealthy motherboard that includes an anomaly (e.g., a missing component), represented by the region in the test image 512. The region 522 in the aggregated image 508, which corresponds to the region 516 that corresponds to an anomaly in the motherboard being tested, includes healthy data because the model is trained only on healthy images.

As a result, comparing the aggregated image 508 with the test image 512 identifies differences because the aggregated image includes healthy data and the input image 512 includes data corresponding to an anomaly. Thus, the comparison engine 510 compares the aggregate image 508 and the test image 512 and generates, in one example, a heatmap 514 of differences. As illustrated, the region 522 of the aggregated image 508 differs from the region 516 in the heatmap 514 more than other regions of the images being compared. The other portions of the heatmap 514 is low (lower colors) or shows little or no difference.

An overlay engine 518 may generate an overlay image 520 that overlays the heatmap 514 on the input image 512. This allows areas of interest to be identified (likely areas that include anomalies) and may focus the efforts of a technician. The evaluation performed by the technician, for instance, may start in the region of interest 524 identified in the overlay image 520 or heatmap 514.

As illustrated in FIG. 5, the result of the inference operation is a set of healthy estimate images, one for each corrupted image. The model reconstructs the image content over the masked region only in one example. The aggregation engine 506 is configured to generate an aggregated image 508 that captures the overall patterns of the reconstructed images via a simple average in one example. Next, the comparison engine 510 may determine absolute pixel-by-pixel differences between the aggregate image 508 and the original input image 512 (or test image t. These differences are normalized and transformed, in one example, into a heatmap (colored when visualized (e.g., displayed on a display) in one example).

The regions (e.g., region of interest 524) of the heatmap 514 that correspond to the highest colors on the color scale correspond to potential regions of missing components on the test motherboard image t 512. When the overlay image 520 (or heatmap 514) is visualized or presented on a display to a technician, the technician can determine whether the test image correspond to a motherboard that is likely unhealthy and indicates a focus area for further inspection.

In images of healthy motherboards, the masked regions are completed with content that is similar to the original test image. As result, the full normalized difference image should be nearly zero in all pixels.

In unhealthy motherboards, regions of the image with missing components or other anomalies, when masked, are completed with content that resembles what a healthy motherboard would look like. As a result, the completed content will likely be very different from the original test image under evaluation across the masked regions for unhealthy motherboards. This difference eventually appears as the higher color values of the heatmap 514.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, inpainting operations, anomaly detection operations, fraud detection operations, image aggregation operations, repair focusing operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, an edge system, an on-premise system, or the like, which is operable to perform operations initiated by one or more clients or other elements of the operating environment.

Example cloud computing environments, which may or may not be public, include storage environments that may provide functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Multimedia objects and other unstructured data may be examples of objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving corrupted images of a computing component into a trained model, wherein the corrupted images are generated from a test image of the component whose status as healthy or unhealthy is not known, generating an output image for each of the corrupted images by the trained model, which is configured to generate output images that are healthy estimate images, aggregating the output images into an aggregated image, comparing the aggregated image with the test image in a comparison; generating a visual representation of the comparison, wherein the visual representation represents that the computing component is healthy or unhealthy.

Embodiment 2. The method of embodiment 1, wherein the computing component is unhealthy when a region of the visual representation represents a difference between the test image and the aggregated image that is greater than a difference between other regions of the test image and the aggregated image.

Embodiment 3. The method of embodiment 1 and/or 2, further comprising corrupting the test image to generate the corrupted images, wherein each of the corrupted images is generated by placing a mask over a region of the test image, wherein the masked regions for each of the corrupted images is in a different location of the test image.

Embodiment 4. The method of embodiment 1, 2, and/or 3, wherein the aggregated image is an average of the output images.

Embodiment 5. The method of embodiment 1, 2, 3, and/or 4, wherein the visual representation comprises a heatmap or an overlay of the heatmap with the test image, further comprising identifying one or more regions of interest in the visual representation having higher colors than other areas of the heatmap, and wherein differences identified in the comparison and represented in the heatmap are normalized.

Embodiment 6. The method of embodiment 1, 2, 3, 4, and/or 5, wherein the one or more regions of interest indicate that the computing component is unhealthy, wherein the computing component is deemed healthy when the region of interest is not present in the visual representation.

Embodiment 7. The method of embodiment 1, 2, 3, 4, 5, and/or 6, wherein the unhealthy status comprises a missing element of the computing component.

Embodiment 8. The method of embodiment 1, 2, 3, 4, 5, 6, and/or 7, wherein the computing component comprises a motherboard.

Embodiment 9. The method of embodiment 1, 2, 3, 4, 5, 6, 7, and/or 8, further comprising evaluating the computing component starting at locations corresponding to the one or more regions of interest.

Embodiment 10. The method of embodiment 1, 2, 3, 4, 5, 6, 7, 8, and/or 9, wherein the model is an inpainting model, and the model is trained from scratch using corrupted images generated only from healthy images such that the model is configured to fill areas corresponding to masks in the corrupted images with data corresponding to healthy images.

Embodiment 11. The method of embodiment 1, 2, 3, 4, 5, 6, 7, 8, 9, and/or 10, wherein the visual representation identifies anomalies in the computing component as regions having a higher pixel difference than other regions.

Embodiment 12. The method of embodiment 1, 2, 3, 4, 5, 6, 7, 8, 9, 10, and/or 11, further comprising generating the test image by photographing the computing component.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

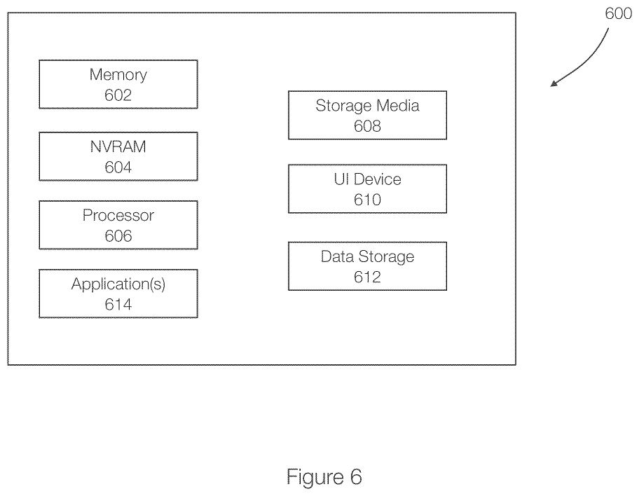

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual, containerized, or physical. The device 600 may perform or execute steps or acts of the methods/operations illustrated in the Figures and described herein.

The device 600 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
receiving corrupted images of a computing component into a trained model, wherein the corrupted images are generated from a test image of the component whose status as healthy or unhealthy is not known;
generating an output image for each of the corrupted images by the trained model, which is configured to generate output images that are healthy estimate images;
aggregating the output images into an aggregated image;
comparing the aggregated image with the test image in a comparison;
generating a visual representation of the comparison, wherein the visual representation represents that the computing component is healthy or unhealthy.

2. The method of claim 1, wherein the computing component is unhealthy when a region of the visual representation represents a difference between the test image and the aggregated image that is greater than a difference between other regions of the test image and the aggregated image.

3. The method of claim 2, further comprising corrupting the test image to generate the corrupted images, wherein each of the corrupted images is generated by placing a mask over a region of the test image, wherein the masked regions for each of the corrupted images is in a different location of the test image.

4. The method of claim 3, wherein the aggregated image is an average of the output images.

5. The method of claim 1, wherein the visual representation comprises a heatmap or an overlay of the heatmap with the test image, further comprising identifying one or more regions of interest in the visual representation having higher colors than other areas of the heatmap, and wherein differences identified in the comparison and represented in the heatmap are normalized.

6. The method of claim 5, wherein the one or more regions of interest indicate that the computing component is unhealthy, wherein the computing component is deemed healthy when the region of interest is not present in the visual representation.

7. The method of claim 6, wherein the unhealthy status comprises a missing element of the computing component.

8. The method of claim 7, wherein the computing component comprises a motherboard.

9. The method of claim 6, further comprising evaluating the computing component starting at locations corresponding to the one or more regions of interest.

10. The method of claim 1, wherein the model is an inpainting model, and the model is trained from scratch using corrupted images generated only from healthy images such that the model is configured to fill areas corresponding to masks in the corrupted images with data corresponding to healthy images.

11. The method of claim 1, wherein the visual representation identifies anomalies in the computing component as regions having a higher pixel difference than other regions.

12. The method of claim 1, further comprising generating the test image by photographing the computing component.

13. A non-transitory storage medium having stored therein instructions that are executable by one or more hardware processors to perform operations comprising:
receiving corrupted images of a computing component into a trained model, wherein the corrupted images are generated from a test image of the component whose status as healthy or unhealthy is not known;
generating an output image for each of the corrupted images by the trained model, which is configured to generate output images that are healthy estimate images;
aggregating the output images into an aggregated image;
comparing the aggregated image with the test image in a comparison;
generating a visual representation of the comparison, wherein the visual representation represents that the computing component is healthy or unhealthy.

14. The non-transitory storage medium of claim 13, wherein the computing component is unhealthy when a region of the visual representation represents a difference between the test image and the aggregated image that is greater than a difference between other regions of the test image and the aggregated image.

15. The non-transitory storage medium of claim 14, further comprising corrupting the test image to generate the corrupted images, wherein each of the corrupted images is generated by placing a mask over a region of the test image, wherein the masked regions for each of the corrupted images is in a different location of the test image.

16. The non-transitory storage medium of claim 15, wherein the aggregated image is an average of the output images.

17. The non-transitory storage medium of claim 13, wherein the visual representation comprises a heatmap or an overlay of the heatmap with the test image, further comprising identifying one or more regions of interest in the visual representation having higher colors than other areas of the heatmap, and wherein differences identified in the comparison and represented in the heatmap are normalized or wherein the visual representation identifies anomalies in the computing component as regions having a higher pixel difference than other regions, wherein the tests image is generated by photographing the computing component.

18. The non-transitory storage medium of claim 17, wherein the one or more regions of interest indicate that the computing component is unhealthy, wherein the computing component is deemed healthy when the region of interest is not present in the visual representation, wherein the unhealthy status comprises a missing element of the computing component and wherein the computing component comprises a motherboard.

19. The non-transitory storage medium of claim 18, further comprising evaluating the computing component starting at locations corresponding to the one or more regions of interest.

20. The non-transitory storage medium of claim 13, wherein the model is an inpainting model, and the model is trained from scratch using corrupted images generated only from healthy images such that the model is configured to fill areas corresponding to masks in the corrupted images with data corresponding to healthy images.
